(19) United States
(12) Patent Application Publication
(10) Pub. No.: US 2024/0375309 A1
(43) Pub. Date: Nov. 14, 2024

(54) ELECTRO-THERMAL KNIFE WITH ANGLE-ADJUSTABLE KNIFE HOLDER

(71) Applicant: CHANGZHOU KENDI ELECTRICAL APPLIANCE MANUFACTURING CO., LTD, Changzhou, Jiangsu (CN)

(72) Inventor: Jianwei SHAO, Changzhou, Jiangsu (CN)

(21) Appl. No.: 18/689,683

(22) PCT Filed: Aug. 29, 2022
(86) PCT No.: PCT/CN2022/115357

§ 371 Date: Mar. 6, 2024

(30) Foreign Application Priority Data
Sep. 10, 2021 (CN) 202122204274.0

(51) Int. Cl. B26D 7/10; B26B 1/04

(52) U.S. Cl. CPC B26D 7/10; B26B 1/04

(57) ABSTRACT

Disclosed is an electro-thermal knife with an angle-adjustable knife holder, including: a knife body, a knife holder and an angle adjusting mechanism; where a front end of the knife body is provided with a knife head, and the other end of the knife body is rotatably connected to the knife holder via an angle adjusting structure; arrangement of the angle adjusting mechanism can effectively adjust an angle between the knife body and the knife holder, thereby facilitating the use of the electro-thermal knife in an environment where it is not used.

### TECHNICAL FIELD

The present invention relates to the field of electro-thermal knives, and in particular to an electro-thermal knife with an angle-adjustable knife holder.

### BACKGROUND ART

There are two main types of electro-thermal knives operated with different principles on the market. A relatively simple one type is implemented by installing a heating wire inside the knife to generate heat after being electrified. Such an electro-thermal knife have advantages of being cheap, low in cost and simple in structure. Another type is a hand-held electro-thermal knife that generates heat with resistance of a blade under a high current. Such an electro-thermal knife has a short warm-up time, and can reach a red state as long as a few seconds, and has a high efficiency. Such an electro-thermal knife have advantages of rapid preheating, high efficiency (direct use of blades to generate heat with little loss), being fast, and variable shapes, different power blades can be selected according to different applications, there is a wide range of applications, and it can be used to cut low melting point products such as foams, sponges, plastics, chemical fiber cloths, non-woven fabrics, filter cloths, plastic ropes, rubbers, stretchable woven mesh tubes, etc.

However, all the electro-thermal knife bodies and knife holders on the market at present are integrated, i.e., in the process of use, the angle between the knife body and the knife holder cannot be adjusted according to the use status, thus bringing great inconvenience to the use. Therefore, it is urgent to provide an electro-thermal knife with an angle-adjustable knife holder to solve the above-mentioned problems.

### SUMMARY OF THE INVENTION

For this reason, there is a need to provide an electro-thermal knife with an angle-adjustable knife holder that is easy to use.

In order to achieve the above objective, the inventor has provided an electro-thermal knife with an angle-adjustable knife holder including: a knife body, a knife holder and an angle adjusting mechanism; where a front end of the knife body is provided with a knife head, and the other end of the knife body is rotatably connected to the knife holder via an angle adjusting structure.

As a preferred structure of the present invention, a first groove is provided on one side of a section of the end of the knife body away from the knife head, a first lug and a second lug are symmetrically provided on the top end of the knife holder, a through-hole is provided at the center of the first lug, and a plurality of limiting slots are arranged on one side of the first lug facing the second lug with the through-hole as the center of a circle; the angle adjusting structure includes a lock button and an elastic piece, where one side of the lock button is provided with a pressing portion, and a plurality of limiting ribs adapted to the limiting slots are uniformly arranged one side of the lock button provided with the pressing portion with the center of the lock button as the center of a circle; one end of the knife body away from the knife head is arranged between the first lug and the second lug, one end of the elastic piece is arranged in the first groove, the other end of the elastic piece is connected to the lock button, one side of the lock button provided with the limiting rib is arranged towards the first lug, the pressing portion of the lock button is arranged in the through-hole, and the limiting rib is adapted to be connected to the limiting slot.

As a preferred structure of the present invention, a fixing groove is provided in the first groove, a fixing rib adapted to the fixing groove is provided on the other side of the lock button away from the pressing portion, and the fixing rib is adapted to be connected to the fixing groove.

As a preferred structure of the present invention, a spring limiting seat is provided at the center of the bottom surface of the first groove, the elastic piece is a spring, and one end of the spring is provided in the spring limiting seat.

As a preferred structure of the present invention, a side wall of the spring limiting seat is provided with a plurality of first notches, an end of the side wall of each section of the spring limiting seat at the first notch is respectively provided with an extension extending towards the side wall of the first groove, a fixing groove is formed between the two connected extensions at the first notches, and the other side of the lock button away from the pressing portion is provided with a fixing rib adapted to the fixing groove.

As a preferred structure of the present invention, a second groove is provided at the center of the other side of the lock button away from the pressing portion, and one end of the spring connected to the lock button is provided in the second groove.

As a preferred structure of the present invention, a wire binding buckle is provided on a side of the second lug facing the first lug, and a wire inlet hole is provided on a side of the end of the knife body adjacent to the wire binding buckle.

As a preferred structure of the present invention, a support including a connecting rod and a support plate is further included, where one end of the connecting rod is fixedly connected to the knife body, the other end of the connecting rod extends towards the knife head, and the end thereof is provided with a support plate arranged perpendicular to the knife head in space.

As a preferred structure of the present invention, an end of the support plate adjacent to the knife head is provided with a second notch through which the knife head passes.

Compared with the prior art, the beneficial effects achieved by the above-mentioned technical solution are that arrangement of the angle adjusting mechanism can effectively adjust an angle between the knife body and the knife holder, thereby facilitating the use of the electro-thermal knife in a environment where it is not used.

### BRIEF DESCRIPTION OF THE DRAWINGS

FIG. 1 is a schematic structural diagram showing an electro-thermal knife according to an embodiment;

FIG. 2 is a first exploded view of an electro-thermal knife according to an embodiment;

FIG. 3 is a second exploded view of an electro-thermal knife according to an embodiment;

FIG. 4 is an enlarged sectional view of an electro-thermal knife according to an embodiment;

FIG. 5 is a schematic structural diagram showing a wire binding buckle according to an embodiment;

FIG. 6 is a schematic structural diagram showing a fixing groove according to an embodiment;

FIG. 7 is a schematic structural diagram showing installation of a lock button according to an embodiment;

FIG. 8 is a schematic structural diagram showing a support according to an embodiment;

FIG. 9 is a diagram showing a state in which the knife body and the knife holder of the electro-thermal knife have different angles according to an embodiment.

### REFERENCE NUMERALS

101. knife body; 102. knife head; 103. knife holder; 104. first lug; 105. second lug; 106. through-hole; 201. first groove; 202. lock button; 203. spring; 204. pressing portion; 205. limiting rib; 206. limiting slot; 207. spring limiting seat; 208. first notch; 209. extension; 210. fixing groove; 211. fixing rib; 212. second groove; 301. heat dissipation fan; 302. heat dissipation hole; 303. wire binding buckle; 304. wire inlet hole; 401. connecting rod; 402. support plate; 403. second notch.

### DETAILED DESCRIPTION OF THE INVENTION

In order to explain the technical contents, structural features, realized objectives and effects of the technical solutions in detail, the following detailed description is given in conjunction with the specific embodiments and the accompanying drawings.

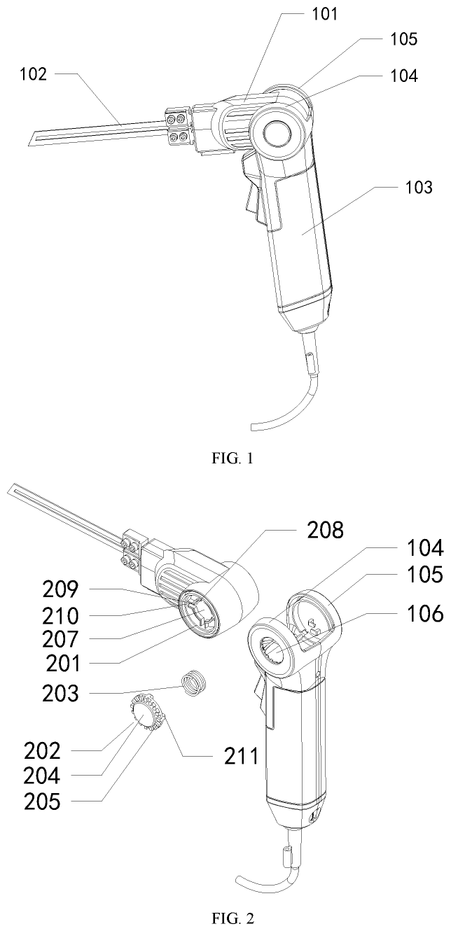

Referring to FIGS. 1 to 9 together, as shown in the drawings, the present embodiment provides an electro-thermal knife with an angle-adjustable knife holder, which includes: a knife body 101, a knife holder 103 and an angle adjusting mechanism; a knife head 102 is provided at a front end of the knife body, and the other end of the knife body is rotatably connected to the knife holder via an angle adjusting structure.

In the present embodiment, the angle adjusting mechanism is provided to effectively adjust the angle between the knife body and the knife holder (as shown in FIG. 9), thereby facilitating the electro-thermal knife to be used in an environment where it is not used.

In the above-mentioned embodiments, as shown in FIGS. 2-7, a first groove 201 is provided at one side of a section of an end of the knife body away from the knife head, a first lug 104 and a second lug 105 are symmetrically provided at the top end of the knife holder, a through-hole 106 is provided at the center of the first lug, and a plurality of limiting slots 206 are arranged on one side of the first lug facing the second lug with the through-hole as the center of a circle; the angle adjusting structure includes a lock button 202 and an elastic piece, where one side of the lock button is provided with a pressing portion 204, and one side of the lock button provided with the pressing portion is uniformly arranged with a plurality of limiting ribs 205 adapted to the limiting slots with the center of the lock button as the center of a circle; one end of the knife body away from the knife head is arranged between the first lug and the second lug, one end of the elastic piece is arranged in the first groove, the other end of the elastic piece is connected to the lock button, one side of the lock button provided with the limiting rib is arranged towards the first lug, the pressing portion of the lock button is arranged in the through-hole, and the limiting rib 205 is adapted to be connected to the limiting slot 206; in the present embodiment, the lock button can be pressed inwards by pressing the pressing portion, so that the limiting rib is disengaged from the limiting slot, and at this time, the knife holder is rotated, i.e., an included angle between the knife body and the knife holder can be adjusted, the lock button is released, and the lock button automatically rebounds under the elastic force of the elastic piece, so that the limiting rib falls into the limiting slot again, and at this time, the knife holder is locked.

In order to keep the lock button 202 fixed when no angle needs to be adjusted, in the present embodiment, a fixing groove 210 is provided in the first groove, a fixing rib 211 adapted to the fixing groove is provided on the other side of the lock button away from the pressing portion, and the fixing rib is adapted to be connected to the fixing groove.

In the above-mentioned embodiment, as shown in FIGS. 2, 6 and 7, a spring limiting seat 207 is provided at the center of the bottom surface of the first groove, the elastic piece is a spring 203, and one end of the spring is provided in the spring limiting seat. A side wall of the spring limiting seat is provided with a plurality of first notches 208, an end of the side wall of each section of the spring limiting seat at the first notch is respectively provided with an extension 209 extending towards the side wall of the first groove, a fixing groove 210 is formed between the two connected extensions at the first notches, and the other side of the lock button away from the pressing portion is provided with a fixing rib 211 adapted to the fixing groove; in the present embodiment, the fixing groove and the fixing rib can be arranged to enable the lock button to keep locked when the angle does not need to be adjusted, i.e., one side of the lock button with the pressing portion is connected to the limiting slot provided on the second lug via the limiting rib, and one side of the lock button away from the pressing portion is connected to the fixing groove via the fixing rib; when the angle needs to be adjusted, the lock button is pressed down, and the spring is compressed; at this time, the limiting rib provided on one side of the lock button with the pressing portion is disengaged from the limiting slot, and the fixing rib provided on one side of the lock button away from the pressing portion is pressed into the fixing groove, i.e., the fixing groove and the fixing rib can be arranged to make the lock button be always in a fixed/stationary state with respect to the knife body.

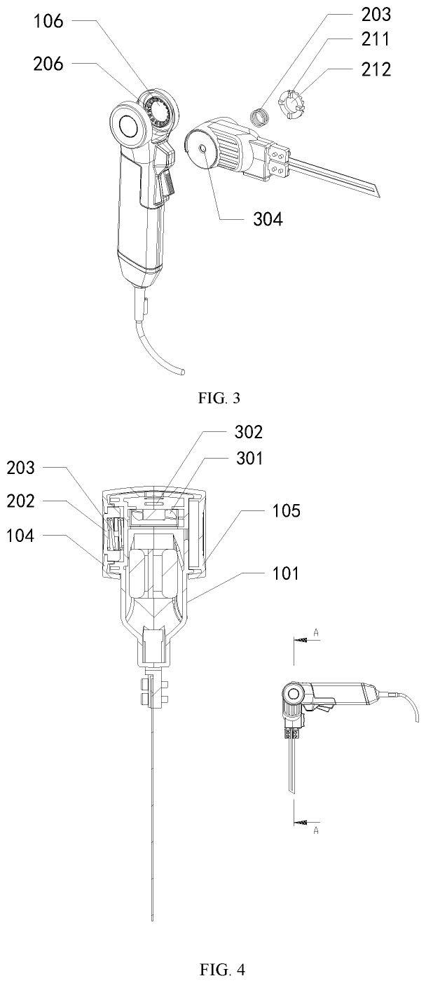

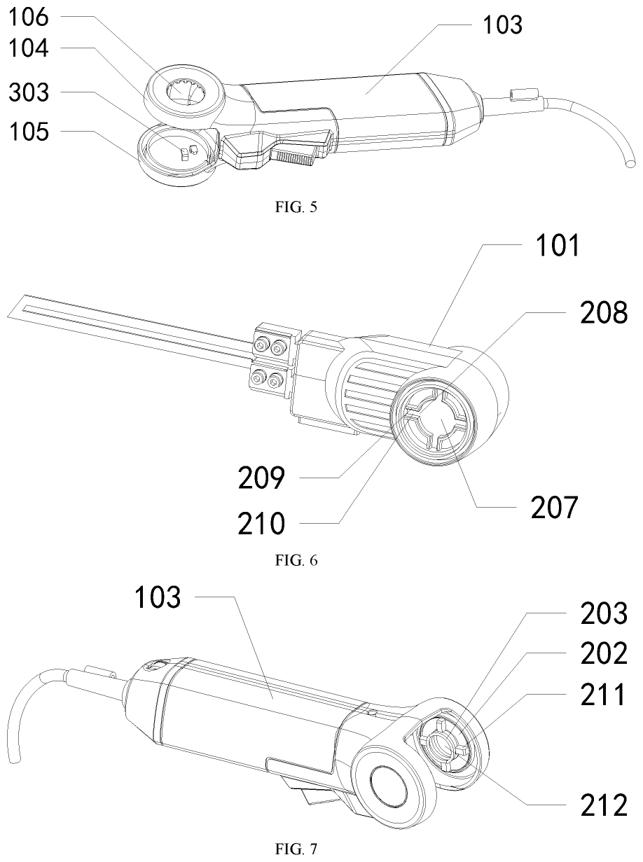

In the above-mentioned embodiment, in order to improve the stability of the spring, one end of the spring is provided in the spring limiting seat 207, and the other end of the spring is provided in a second groove 212 provided at the center of the other side of the lock button away from the pressing portion (as shown in FIG. 2), i.e., the stability of the spring during compression and extension can be effectively improved. In order to facilitate the wire inlet and the thread discharging, as shown in FIGS. 3 and 5, a wire binding buckle 303 is provided on a side of the second lug facing the first lug, and a wire inlet hole 304 is provided on a side of an end of the knife body end adjacent to the wire binding buckle.

In some embodiments, in order to improve the heat dissipation performance of the knife body of the electro-thermal knife, a heat dissipation fan 301 is provided in the end of the knife body located between the first lug and the second lug, and a plurality of heat dissipation holes 302 are provided on an outer housing of the end of the knife body.

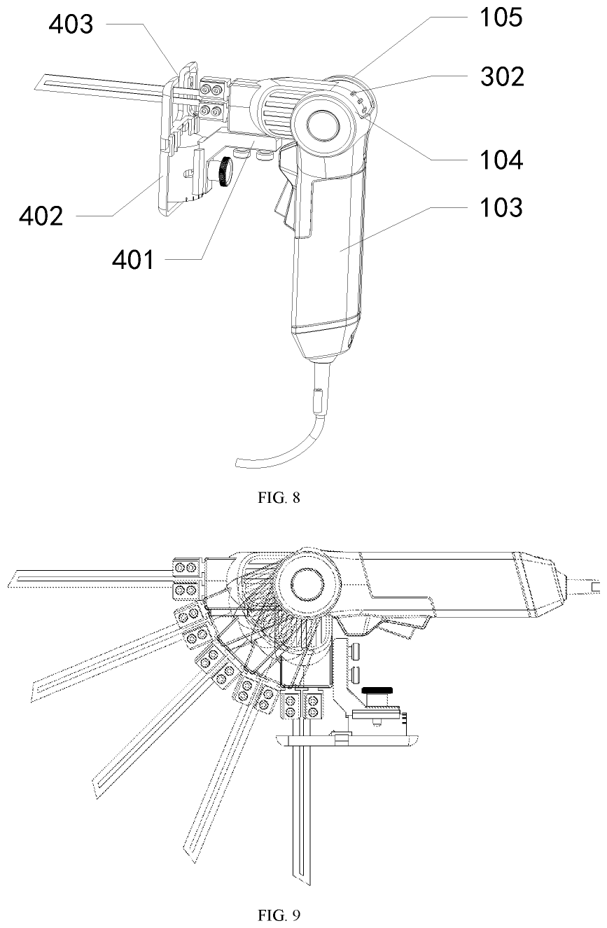

In different embodiments, as shown in FIG. 8, in order to further facilitate the use of an electro-thermal knife, a support can also be provided, where the support includes a connecting rod 401 and a support plate 402, one end of the connecting rod is fixedly connected to the knife body, the other end of the connecting rod extends towards the knife head, and the end thereof is provided with a support plate arranged perpendicular to the knife head in space; in the present embodiment, the support plate is provided to effectively improve the use experience, i.e., when the planar material is cut, the support plate can be placed on the planar material, and then the electro-thermal knife can be pushed. In some embodiments, the end of the support plate adjacent to the end of the knife head is provided with a second notch 403 through which the knife head passes.

It should be noted that while the above-described embodiments have been described herein, it is not intended to limit the scope of the present invention. Therefore, based on the innovative concepts of the present invention, the technical solutions of the present invention can be directly or indirectly applied to other related technical fields by changing and modifying the embodiments described herein or by using the equivalent structures or equivalent processes of the content of the description and the attached drawings, and are included in the protection scope of the present invention.

1. An electro-thermal knife with an angle-adjustable knife holder, comprising: a knife body, a knife holder and an angle adjusting mechanism; wherein a front end of the knife body is provided with a knife head, and the other end of the knife body is rotatably connected to the knife holder via an angle adjusting structure;
a first groove is provided on one side of an end of the knife body away from the knife head, a first lug and a second lug are symmetrically provided on the top end of the knife holder, a through-hole is provided at the center of the first lug, and a plurality of limiting slots are arranged on one side of the first lug facing the second lug with the through-hole as the center of a circle.

2. The electro-thermal knife with an angle-adjustable knife holder according to claim 1, wherein
the angle adjusting structure comprises a lock button and an elastic piece, one side of the lock button is provided with a pressing portion, and a plurality of limiting ribs adapted to the limiting slots are uniformly arranged one side of the lock button provided with the pressing portion with the center of the lock button as the center of a circle;
one end of the knife body away from the knife head is arranged between the first lug and the second lug, one end of the elastic piece is arranged in the first groove, the other end of the elastic piece is connected to the lock button, one side of the lock button provided with the limiting rib is arranged towards the first lug, the pressing portion of the lock button is arranged in the through-hole, and the limiting rib is adapted to be connected to the limiting slot.

3. The electro-thermal knife with an angle-adjustable knife holder according to claim 2, wherein a fixing groove is provided in the first groove, a fixing rib adapted to the fixing groove is provided on the other side of the lock button away from the pressing portion, and the fixing rib is adapted to be connected to the fixing groove.

4. The electro-thermal knife with an angle-adjustable knife holder according to claim 2, wherein a spring limiting seat is provided at the center of the bottom surface of the first groove, the elastic piece is a spring, and one end of the spring is provided in the spring limiting seat.

5. The electro-thermal knife with an angle-adjustable knife holder according to claim 4, wherein a side wall of the spring limiting seat is provided with a plurality of first notches, an end of the side wall of each section of the spring limiting seat at the first notch is respectively provided with an extension extending towards the side wall of the first groove, a fixing groove is formed between the two connected extensions at the first notches, and the other side of the lock button away from the pressing portion is provided with a fixing rib adapted to the fixing groove.

6. The electro-thermal knife with an angle-adjustable knife holder according to claim 4, wherein a second groove is provided at the center of the other side of the lock button away from the pressing portion, and one end of the spring connected to the lock button is provided in the second groove.

7. The electro-thermal knife with an angle-adjustable knife holder according to claim 2, wherein a heat dissipation fan is provided in an end of the knife body located between the first lug and the second lug, and a plurality of heat dissipation holes are provided on an outer housing of the end of the knife body.

8. The electro-thermal knife with an angle-adjustable knife holder according to claim 2, wherein a wire binding buckle is provided on a side of the second lug facing the first lug, and a wire inlet hole is provided on a side of the end of the knife body adjacent to the wire binding buckle.

9. The electro-thermal knife with an angle-adjustable knife holder according to claim 1, further comprising a support comprising a connecting rod and a support plate, wherein one end of the connecting rod is fixedly connected to the knife body, the other end of the connecting rod extends towards the knife head, and the end thereof is provided with a support plate arranged perpendicular to the knife head in space.

10. The electro-thermal knife with an angle-adjustable knife holder according to claim 9, wherein an end of the support plate adjacent to the knife head is provided with a second notch through which the knife head passes.
